(19) United States
(12) Patent Application Publication
(10) Pub. No.: US 2020/0334737 A1
(43) Pub. Date: Oct. 22, 2020

(54) PERSONALIZED PRODUCT RECOMMENDATION ENGINE

(71) Applicant: Origins Enterprise, LLC, Redmond, WA (US)

(72) Inventor: Sean Miller, Sammamish, WA (US)

(21) Appl. No.: 16/851,014

(22) Filed: Apr. 16, 2020

Related U.S. Application Data
(60) Provisional application No. 62/835,433, filed on Apr. 17, 2019.

(51) Int. Cl. G06Q 30/06

(52) U.S. Cl. CPC G06Q 30/0631; G06Q 30/0643; G06Q 30/0639

(57) ABSTRACT

Described herein are a system and techniques directed toward identifying personalized recommendations for a user for products which are non-uniform and/or which are not easily equated across retailers. In some embodiments, this may involve using one or more clustering techniques to identify a cluster into which the user belongs. The system may ascertain, based on cluster data, an effect that the product is likely to have on the user. The user's preferences (e.g., lifestyle and consumption method) may then be used to identify a likelihood that a product's likely effect on a user is one desired by the user. Products may then be ranked based on those likelihoods and products with the highest likelihood may be presented to the user.

### BACKGROUND

With the legalization of marijuana in some states, the popularity of cannabis products has greatly increased in recent years. Cannabis and hemp products often vary greatly in both performance and effect, and often on a person-by-person basis. It is difficult to determine, before purchasing the product, whether the product will provide a user the experience that they are looking for.

Additionally, cannabis and hemp products are often farmed in relatively small batches, often by independent farmers. Hence, certain cannabis or hemp products or strains may only be available to a limited number of cannabis retailers. On the other hand, products offered for sale may also vary greatly between retail stores. It is often difficult to ascertain which products from one retailer will provide an equivalent effect to a product that a user prefers which is offered by a different retailer

Embodiments of the disclosure address these and other problems, individually and collectively.

### BRIEF SUMMARY

Described herein are a system and techniques directed toward a recommendation engine which generates extremely personalized and relevant product recommendations and recommended articles with respect to non-uniform and small-batch products (e.g., cannabis and hemp). The disclosed recommendation engine is powered by a large variety of inputs. Some inputs are direct, such as a user's individual purchase history, similar demographic purchase history, ratings of products and experiences, and taste profiles and preferences. Other inputs are indirect, such as attributes about the products that users have purchased or demographic information derived from their address, date of birth, sex, etc.

The disclosed recommendation engine outputs content (product, lifestyle, article) to be presented and recommended. The engine may directly notify customers (e.g., via push notifications and text messages) and may also present recommendations to in-store customer service guides when users are shopping in a physical retail store. The engine may notify a user about recommendations at optimal times. The disclosed system may also be configured to determine an optimal time at which to send such a notification. Users of the disclosed system may also have the ability to research and purchase/reserve products directly via the consumer application using single sign on technology.

One embodiment of the disclosure is directed toward a computer-implemented method comprising: receiving a request to provide a personalized product recommendation to a user, determining, based on attributes associated with the user, a cluster to which the user belongs, determining, based on information stored in association with the cluster, a likely effect for each of a set of products, identifying a preferred lifestyle for the user, identifying a subset of the set of products for which the determined likely effect matches the preferred lifestyle, and providing, by the service provider computer, an indication of the subset of the set of products in response to the request.

Another embodiment of the disclosure is directed toward a service provider computer comprising: a processor; and a memory including instructions that, when executed with the processor, cause the service provider computer to, at least: receive a request to provide a personalized product recommendation to a user, determine, based on attributes associated with the user, a cluster to which the user belongs, determine, based on information stored in association with the cluster, a likely effect for each of a set of products, identify a preferred lifestyle and cannabinoid ratio for the user, identify a subset of the set of products for which the determined likely effect matches the preferred lifestyle, and provide an indication of the subset of the set of products in response to the request.

These and other embodiments of the disclosure are described in further detail below.

### BRIEF DESCRIPTION OF THE DRAWINGS

FIG. 1 depicts an illustrative example of a system overview in which personalized product recommendations can be generated and provided to a user in accordance with at least some embodiments;

FIG. 2 depicts a diagram of an exemplary service provider that may be configured to generate personalized product recommendations in accordance with at least some embodiments;

FIG. 3 depicts a flow chart illustrating an example process for providing personalized product recommendations for a user in a physical location in accordance with at least some embodiments of the disclosure;

FIG. 4 depicts a technique for assigning a value to a user based on feedback received from that user in accordance with embodiments described herein;

FIG. 5 depicts a process for generating personalized product recommendations for a user based on a selection of lifestyle and location in accordance with at least some embodiments;

FIG. 6 depicts an illustrative example of various graphical user interfaces (GUIs) that may be implemented in accordance with at least some embodiments; and

FIG. 7 depicts a flow diagram illustrating a process for providing a product recommendation in accordance with at least some embodiments.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Described herein is a recommendation system configured to identify personalized recommendations for products which are non-uniform and/or which are not easily equated across retailers. In some embodiments, this may involve using one or more clustering techniques to identify a cluster into which the user belongs. The system may ascertain, based on cluster data, an effect that the product is likely to have on the user. The user's preferences (e.g., lifestyle and consumption method) may then be used to identify a likelihood that a product's likely effect on a user is one desired by the user. Products may then be ranked based on those likelihoods and products with the highest likelihood may be presented to the user. In some embodiments, product availability may vary greatly across geographic regions. In these embodiments, only products within a geographic radius of the user may be considered and the presented products may further be sorted according to distance from the user.

In certain embodiments, the system receives information (e.g., cannabinoid content) for each product offered by each retailer. In some of these embodiments, the retailer may provide this information to the system. In some embodiments, a producer of a particular product may provide this information to the system along with information on what retailers/locations offer the product.

Each product for which information is provided is given a numerical value based on its respective information which represents a ratio of cannabinoids (i.e., a cannabinoid ratio) for the product. Product recommendations are then generated by the system based on this cannabinoid ratio and based on whether a likely effect that the product would have on the user matches a desired lifestyle of the user. This used to allow algorithms to properly identify product fit. Additionally, in some embodiments, terpene content may be used as a secondary factor in providing product recommendations.

Details of some embodiments of the present disclosure will now be described in greater detail with respect to the figures.

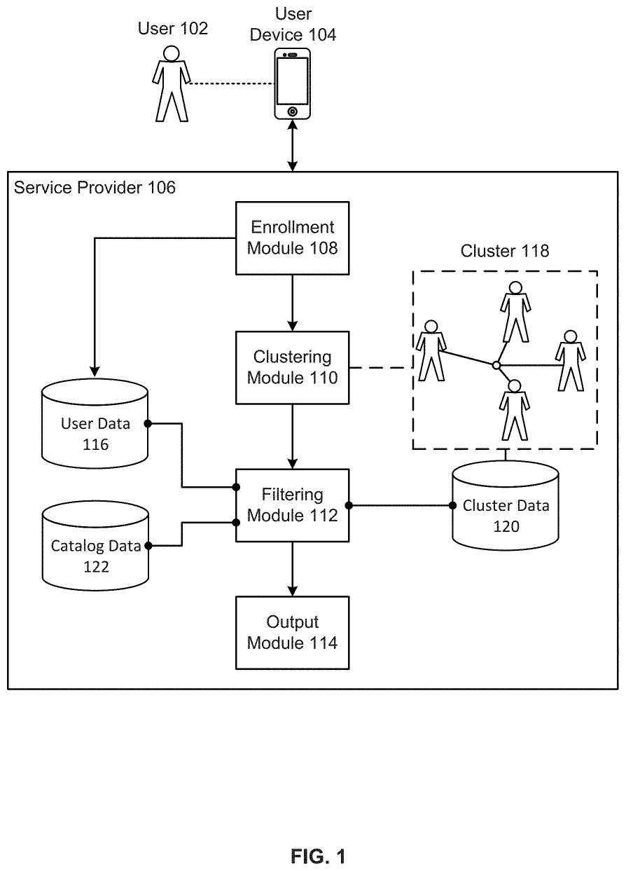

FIG. 1 depicts an illustrative example of a system overview in which personalized product recommendations can be generated and provided to a user in accordance with at least some embodiments. In FIG. 1, a user 102 may utilize a user device 104 to interact with a service provider 106. The service provider 106, upon receiving user data from the user device 104, may then generate a personalized product recommendation as described below.

The user device 104 may be any suitable device capable of being used by a user to interact with the service provider 106. For example, a user device 104 may be a laptop or a mobile phone. In accordance with at least some embodiments, interaction between a service provider 106 and a user device 104 may occur via a mobile application installed upon, and executed from, the user device 104. In some embodiments, interaction between a service provider 106 and a user device 104 may occur via a web browser application (e.g., via a website operated on behalf of the service provider 106). During interactions between the service provider 106 and the user device 104, various user data may be conveyed to the service provider 106. This user data may be input by a user 102, obtained from the memory of the user device 104, or some combination of the two.

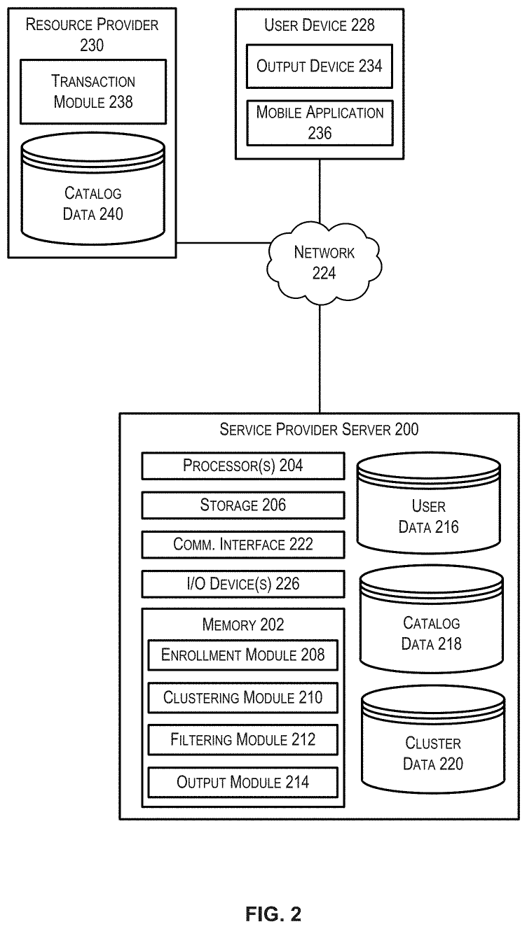

The service provider 106 may be any type of computing device capable of performing at least a portion of the functionality described herein. The service provider 106 may include some or all of the modules described herein, to include an enrollment module 108, a clustering module 110, a filtering module 112, and an output module 114. Each of these modules is described in greater detail below (with respect to FIG. 2).

In some embodiments, the service provider 106 may include an enrollment module 108 which obtains information from a user. The service provider 106 may maintain one or more accounts associated with a user 102 and/or user device 104. Each of these accounts may be associated with user data 116 stored with respect to that account. The enrollment module 108, during an enrollment phase in which an account is created for a user, may obtain data that includes demographic information, preferences, an indicated lifestyle, physical attributes (e.g., height, weight, gender, etc.), or any other suitable information. The enrollment module 108 may assign an account to the user and store the obtained data in relation to that account.

By way of illustrating an example of an enrollment module 108, consider a scenario in which the service provider 106 provides recommendations regarding cannabis use. In this scenario, when the customer signs up for an account with the service provider, they may go through an onboarding survey which asks questions about their goals with cannabis, which may include “What are you looking to get from cannabis?” and “How do you like to consume your cannabis?” The answers to the user's questions may be used to discern the customer's preferred “Lifestyle” (a proprietary product categorization representing a user's desired product effect), as well as the customer's preferred “Consumption Method” (such as Vape, Edibles, Flower, etc.). These data points, along with purchase history and browsing history, may then be stored in user data 116 and used for future relevant search suggestions. In some embodiments, the data may be used by online menus to create a customized view for customers based on their preferences, purchase history and settings.

In some embodiments, the service provider 106 may include a clustering module 110 which assigns a user to a cluster 118 of similar users. Cluster 118 of similar users may have stored preferences and/or purchase history in cluster data 120. It should be noted that clustering module 118 may use any suitable clustering technique to assign a user to a cluster 118.

In some embodiments, the service provider 106 may include a filtering module 112 which, given a catalog of available products (catalog data 122), identifies products which are appropriate to a user. This may involve performing collaborative filtering based on information stored in cluster data 120, performing content-based filtering using information stored in user data 116, or some combination of both.

In some embodiments, the service provider 106 may include an output module 114 which provides a personalized recommendation to the user 102. In some embodiments, the output module 114 may provide a notification to the user device 104 via direct messaging (e.g., Push Notification via a mobile application, Short Messaging Service (SMS), or Email). In some embodiments, the output module 114 may provide a notification to a resource provider agent (e.g., an in-store employee). One or more personalized recommendations may be provided to a dashboard of a mobile application and/or website to be viewed via a graphical user interface (GUI) of the user device 104.

For clarity, a certain number of components are shown in FIG. 1. It is understood, however, that embodiments of the disclosure may include more than one of each component. In addition, some embodiments of the disclosure may include fewer than or greater than all of the components shown in FIG. 1. In addition, the components in FIG. 1 may communicate via any suitable communication medium (including the internet), using any suitable communication protocol.

FIG. 2 depicts a diagram of an exemplary service provider 200 that may be configured to generate personalized product recommendations in accordance with at least some embodiments. The service provider 200 may be an example service provider 106 described with respect to FIG. 1.

The service provider 200 may be any type of computing device capable of receiving user data and products available from one or more resource providers and providing a personalized product recommendation for a user. In at least some embodiments, the service provider 200 may include at least one memory 202 and one or more processing units (or processor(s)) 204. The processor(s) 204 may be implemented as appropriate in hardware, computer-executable instructions, firmware or combinations thereof. Computer-executable instruction or firmware embodiments of the processor(s) 204 may include computer-executable or machine executable instructions written in any suitable programming language to perform the various functions described.

The memory 202 may store program instructions that are loadable and executable on the processor(s) 204, as well as data generated during the execution of these programs. Depending on the configuration and type of service provider 200, the memory 202 may be volatile (such as random access memory (RAM)) and/or non-volatile (such as read-only memory (ROM), flash memory, etc.). The service provider 200 may also include additional storage 206, such as either removable storage or non-removable storage including, but not limited to, magnetic storage, optical disks, and/or tape storage. The disk drives and their associated computer-readable media may provide non-volatile storage of computer-readable instructions, data structures, program modules, and other data for the service provider 200. In some embodiments, the memory 202 may include multiple different types of memory, such as static random access memory (SRAM), dynamic random access memory (DRAM) or ROM.

Turning to the contents of the memory 202 in more detail, the memory 202 may include an operating system and one or more application programs or services for implementing the features disclosed herein including at least a module for obtaining user data (enrollment module 208), a module for assigning a user to a cluster (clustering module 210), a module for filtering a set of products to a recommended subset of products (filtering module 212), and a module for providing a product recommendation to another entity (output module 214). The memory 202 may also include a number of data stores, including user data 216, which maintains information associated with individual users, catalog data 218, which maintains information associated with products available from one or more resource providers, and/or clustering data 220, which maintains an assignment of a cluster (or centroid) to which a particular user belongs as well as group preferences associated with clusters. The data stored in databases 216, 218, and 220 may be dynamic, static, or some combination of dynamic and static data. In some embodiments, the service provider 200 may maintain a number of accounts into which users may be required to log in.

In some embodiments, the enrollment module 208 may, in conjunction with the processor 204, be configured to obtain information from the user. In some embodiments, the enrollment module 208 may be configured to create a new account for a user (in the event that the user does not already have an account with the service provider). In some embodiments, this may involve the use of a survey presented to the user device 228. The data collected by the enrollment module 208 may then be used to ascertain a “lifestyle,” and a “consumption method” to be used by other modules. It should be noted that execution of an enrollment module 208 may not be limited to users who do not have an account. For example, an enrollment module 208 may be executed each time that a user browses a product catalog or otherwise imitates a request.

In some embodiments, the clustering module 210 may, in conjunction with the processor 204, be configured to determine, based on data related to a user (e.g., demographic information, item reviews, item purchase history information, etc.) , a “cluster” or group of consumers to which the user likely belongs. The clustering module 210 may assign a consumer to a cluster based on item purchases, geographic vicinity, economic similarities, physical attributes (height, weight, gender), or any other suitable user attributes or combination of user attributes. For example, a user may be clustered with other users based on feedback that the user provides with respect to particular products. In this example, a user's feedback for a particular product may be compared to the feedback that other users have provided for products with a similar cannabinoid ratio to the particular product to identify a set of users which likely respond to cannabinoids in the same manner as the user. Any suitable clustering technique may be utilized by the clustering module 210. In some embodiments, a clustering technique may involve identifying positions of users within a multi-dimensional space (where each dimension is associated with a different user attribute) and identifying groups of users within that multi-dimensional space as clusters based on their proximity within the space. Examples of suitable clustering techniques include connectivity-based clustering such as hierarchical clustering, centroid-based clustering such as k-means clustering , distribution-based clustering such as expectation maximization clustering, density-based clustering such as density-based spatial clustering of applications with noise (e.g., DBSCAN), subspace clustering, correlation clustering, and clustering based on genetic algorithms. In some embodiments, a clustering module of the service provider may use a clustering algorithm (e.g., k-means clustering) to assign clusters within a set of users (e.g., all users of the service). In some embodiments, cluster information determined by the clustering module 210 may be recorded in cluster data 220.

In some embodiments, the filtering module 212 may, in conjunction with the processor 204, be configured to generate a personalized product recommendation from a catalog of products (e.g., catalog data 218). The product recommendation may indicate a single product or a set of products. In some embodiments, the filtering module 212 may initially filter products from the catalog data 218 based on logistical constraints (e.g., geographic location, availability, accessibility, etc.). For example, the filtering module 212 may create a subset of products which include each of the products in catalog data 218 within a predetermined distance of the user which are in stock. The filtering module 212 may apply collaborative filtering by reducing that subset of products to those most preferred by a cluster to which the user is assigned. For example, the filtering module 212 may identify products of the subset which are, on average, the highest rated. In some embodiments, products that fail to meet some threshold value (e.g., average rating by the cluster is below four stars) may be removed from the subset. In some embodiments, the service provider 200 may assess feedback provided by the cluster in order to determine an effect that a particular product or cannabinoid ratio has had on that particular cluster. The service provider 200 may then determine an extent to which the determined effects align with a lifestyle desired by the user.

The filtering module 212 may apply content-based filtering by reducing the subset of products based on the user data 216. For example, products may be removed from the subset if the user has previously purchased them and given them a low rating. In another example, product in the subset of products may be ranked based on their similarity to previously-purchased products. In this example, the service provider 200 may calculate a typical “lifestyle,” a typical “consumption method,” and/or a typical “cannabinoid ratio” (e.g., 50:1). The products in the subset of products may then be ranked and/or filtered based upon a comparison of those products to the calculated values. In some embodiments, in the scenario in which the products are cannabis products, the subset of products may be filtered based on an indicated “lifestyle” and/or “consumption method” of the user. In some embodiments, the resulting subset may be ordered in accordance with a determined desirability to the user.

In some embodiments, the output module 214 may, in conjunction with the processor 204, be configured to provide a product recommendation to another entity. In some embodiments, the product recommendation may be provided to a user device 228. In some cases, this may involve sending a notification directly to the user device 228. For example, the output module 214 may provide a push notification to the user device 228 via a mobile application (236) installed upon the user device 228. In another example, the output module 214 may send an SMS message to the user device 228 via a phone number for that user device 228. In yet another example, a set of product recommendations may be provided to a mobile application and presented to a user via a GUI of a user device 228. In some embodiments, the output module 214 may provide an email notification to the user for which the recommendation is intended.

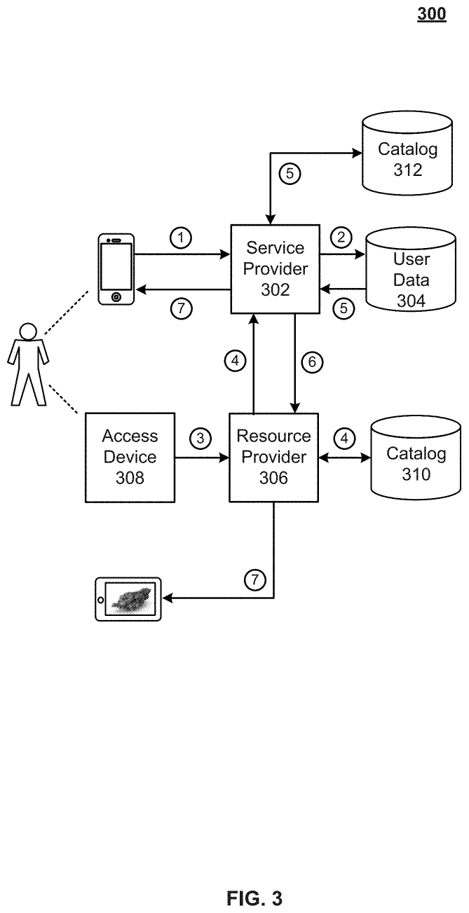

In some embodiments, the output module 214 may be configured to provide a recommendation to a resource provider 230 or an agent of the resource provider 230. For example, upon determining that the user has entered a physical location associated with a resource provider 230, the service provider 200 may generate a set of product recommendations and may provide that set of product recommendations to an employee of the resource provider, who may then present one or more of the recommended products to the user. This is described in greater detail with respect to FIG. 3 below.

User data 216 may include data obtained via the enrollment module 208 described above as well as other information obtained about the user. For example, user data 216 may include a purchase history of the user that indicates products that the user has previously purchased as well as dates and times that the user has made those purchases. The user's check-in events (e.g., dates that the user has entered a particular resource provider) may also be stored. In some embodiments, the user's browsing data (obtained when a user is browsing products) may be stored. Such browsing data may include the search terms that the user typed and an identifier for any products viewed as well as a timestamp and duration for which the product was viewed. User data 216 may also include scores, tags, attributes, and notes about their product purchases. In some embodiments, this data may be stored in a journal format. Additionally, user data 216 may include any other suitable information. For example, user data 216 may include demographic data, advertisement effectiveness data, clickstream data, or any other suitable information related to the user. In some embodiments, user data may include a flavor preference for each user. For example, a user may provide an indication of a terpene strength and/or one or more flavor tags preferred by that user. In some embodiments, the server provider server 200 may identify a preferred terpene strength and/or one or more flavor tags preferred by a user automatically (i.e., without user interaction) based on the user's purchasing patterns and feedback received from that user.

Catalog data 218 may include any information related to products and/or services provided by one or more resource providers 230. In some embodiments, the catalog data 218 may include a product identifier as well as one or more attributes of the product. In the case that the products are cannabis products, the catalog data 218 may store (in addition to an identifier) an indication of a cannabinoid ratio (i.e., a ratio of cannabinoids and terpenes used to determine a lifestyle category, typically represented as a proportion of cannabinoids (such as Cannabidiol (CBD), Cannabinol (CBN), and cannabigerol (CBG)) to Tetrahydrocannabinol (THC)), brand of the product, name of the product, type of the product (edible, flower, pre-roll, etc.), a textual description of the product, and a cannabis strain. In some embodiments, each product may be given a flavor profile that consists of one or more flavor notes. In these embodiments, individual flavor notes may be identified by various users which have provided feedback for the product and the flavor profile may be generated based on those flavor notes. In some embodiments, various flavor notes of a flavor profile for a product may be weighted based on the number of users that have reported each flavor note within the flavor profile.

Cluster data 220 may be predetermined or it may be dynamically generated. For example, purchase preferences and clusters may be updated in real time as input is received. For example, consumers may be added to, or removed from, various clusters as purchases are made or as new information is received regarding the consumer. In some embodiments, the cluster data 220 may maintain aggregated user data. For example, the cluster data 220 may maintain an average rating for one or more products available in the catalog data 218.

The service provider 200 may also contain communications interface(s) 222 that enable the service provider 200 to communicate with a stored database, another computing device or server, one or more remote devices, and/or any other suitable electronic devices. In some embodiments, the communication interface 222 may enable the service provider 200 to communicate with other electronic devices on a network 224 (e.g., on a private network). The service provider 200 may also include input/output (I/0) device(s) and/or ports 226, such as for enabling connection with a keyboard, a mouse, a pen, a voice input device, a touch input device, a display, speakers, a printer, etc.

In some embodiments, the network 224 may include any one or a combination of many different types of networks, such as cable networks, the Internet, wireless networks, cellular networks, and other private and/or public networks. While the illustrated example represents the user device 228 accessing the service provider 200 over the network 224, the described techniques may equally apply in instances where the user device 228 interacts with the service provider 200 over a landline phone, via a kiosk, or in any other manner. It is also noted that the described techniques may apply in other client/server arrangements (e.g., set-top boxes, etc.), as well as in non-client/server arrangements (e.g., locally stored applications, peer to-peer systems, etc.).

The service provider 200 may be in communication with a number of user devices 228 and/or resource providers 230. Each of the user devices 228 may be capable of interacting with the service provider 200 to access an account, obtain recommendations, or make purchases. Additionally, in some embodiments the user devices 228 may be capable of interacting with a resource provider 230 to complete a transaction. For example, the user devices 228 may include a web browser or other application that enables a user of the user device 228 to access a website maintained by the service provider 200 or resource provider 230. In some embodiments, the service provider server 200 may be further configured to complete a purchase from a resource provider 230 on behalf of a user device 228.

The user device 228 may include one or more output devices 234 capable of presenting a recommendation to a user of the user device 228. For example, the output devices 234 may include one or more displays and/or speaker devices capable of presenting visual or audio content. In some embodiments, the user device 228 may include a mobile application 236, which may be a set of computer executable instructions (e.g. an application) which, when executed, causes the user device 228 to present a graphical user interface (GUI) to a user. In some embodiments, a mobile application 236 may be an application which is maintained on behalf of, and supported by, the service provider 200. For example, in some embodiments, the mobile application 236 may be used to access account information and recommendations made available by the service provider 200. In some embodiments, a user device 228 may be independently capable of storing (e.g., in memory) information provided by the service provider 200. In some embodiments, a user device 228 may be capable of continuously receiving data from the service provider 200 (e.g., streaming media) and presenting the received media to a user via the GUI.

The mobile application 236 executed from memory of the user device 228 may be configured to present a set of product recommendations to a user. In some embodiments, the mobile application 236 may be further configured to obtain and relay user feedback related to products. For example, the mobile application 236 may receive a rating or other indication of preference from the user in relation to a particular product. In some embodiments, the mobile application 236 may enable a user to maintain product reviews in a journal format (e.g., a product journal). For example, in the case that the product is a cannabis product, the user may record scores, tags, attributes and notes about their product purchases in a cannabis journal. Additionally, for each product in their purchase history, the customer may be presented with a custom user interface (UI) to allow and walk them through the process of entering information such as: where they felt the effects of the cannabis, measured numerically between head and body; what intensity of effects they felt, measured numerically; what intensity of effects they expected, measured numerically; text entry of their notes regarding their experience such as where they were, who they were with, what they were doing, time of day, etc.; flavors experienced (e.g., by a tagging system); and amount of cannabis consumed (dosage) in terms of ml or mg. In some embodiments, text analysis may be performed on the data collected via the product journal. For example, the service provider 200 may, upon receiving this information, identify significant keys (per user and per product). In another example, the service provider 200 may perform sentiment analysis on the journal data to identify an affinity score (per user and per product). For users that use cannabis products for medicinal purposes, the journal data allows those users to document the user's ailment and the effect that the product has had on the ailment. Processing the journal data allows the system to adjust a dosage and make appropriate recommendations for each ailment.

In some embodiments, a resource provider 230 may be any computing device capable of managing access to one or more resources. In some embodiments, the resource provider 230 may be a retailer (e.g., an electronic retailer) or some other merchant which provides goods and/or services. In some embodiments, the resource provider 230 may include, in its memory, one or more modules for conducting a transaction for a resource (transaction module 238). In some embodiments, the resource provider 230 may store catalog data 240, which may include an electronic catalog of products available from the resource provider 230. The resource provider 230 may provide access to catalog data 240 to an service provider 200, and in some embodiments, the service provider 200 may store at least a portion of the catalog data 240 in catalog data 218. In some embodiments, the catalog data 240 may be stored on a computing device which is separate from the resource provider 230. A resource provider 230 may maintain a physical store, at which a user may purchase one or more products available in the catalog data 240.

FIG. 3 depicts a flow chart illustrating an example process for providing personalized product recommendations for a user in a physical location in accordance with at least some embodiments of the disclosure. The process 300 is illustrated as a logical flow diagram, each block of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be omitted or combined in any order and/or in parallel to implement this process and any other processes described herein.

Some or all of the process 300 (or any other processes described herein, or variations and/or combinations thereof) may be performed under the control of one or more computer systems configured with executable instructions and may be implemented as code (e.g., executable instructions, one or more computer programs or one or more applications). In accordance with at least some embodiments, the process 300 of FIG. 3 may be performed by at least the service provider 200 and user device 228 each depicted in FIG. 2. The code may be stored on a computer-readable storage medium, for example, in the form of a computer program including a plurality of instructions executable by one or more processors. The computer-readable storage medium may be non-transitory.

In some embodiments, process 300 may begin at step 1, when a user enrolls with the service provider 302. This may involve the user providing a number of details related to attributes of the user and/or preferences to the service provider 302. In some cases, this may involve the user taking an onboarding survey or other questionnaire. Once the user has provided user details to the service provider 302, those user details may be stored by the service provider in user data 304 at step 2. It should be noted that steps 1 and 2 are optional steps. The system may be configured to provide a recommendation even when the user does not have an account and when no data is stored by the service provider 302 for the user.

At step 3 of process 300, a resource provider 306 may receive an indication that the user has entered, or is going to enter, a physical location operated by that resource provider 306. In some embodiments, this indication may be received when the user is checked in to the physical location, which may occur via an access device 308. An access device may be any device in communication with the resource provider 306 which provides transaction data (such as data related to a check-in transaction) to the resource provider 306. In some embodiments, the access device may include a barcode reader or other scanner capable of reading a machine-readable code presented by a user. For example, a user may, upon entering a physical store, present his or her driver's license (or other identifier) to a store employee. In this example, the access device may be used to scan a barcode on the driver's license to obtain user details which are then conveyed to the resource provider 306. For example, the access device 308, upon scanning a driver's license, may obtain and send: first name, last name, driver's license ID number, birth date, address information (e.g., city, state, zip), height, weight, and any other suitable data. Additionally, the resource provider 306 may receive information related to the physical store location, such as current weather conditions and/or a location of the store.

At step 4, the resource provider 306 may transmit the information for the user (e.g., the check-in data discussed above) to the service provider 302 to receive a recommendation. Upon receiving this information, the service provider 302 may retrieve data stored in relation to the user at step 5. In some embodiments, the user may not have an account with resource provider 306 and no user data may be retrieved. The service provider 306 may derive demographic information for the user by cross-referencing the user's address with a demographics database. Additionally, the service provider 306 may roughly estimate a body mass index for the user based on the received height and weight data. In some embodiments, the resource provider 306 may retrieve product data from a catalog 310 and send that product data to the service provider 302 at this step. In some embodiments, the service provider 302 may maintain a separate catalog 312 from which it may retrieve product data. As described elsewhere, a personalized product recommendation may then be generated for the user by clustering the user (e.g., using the demographic data and body mass index) and filtering product recommendations based on that clustering.

At step 6 of the process 300, the service provider 302 may provide a set of recommended products to the resource provider 306. In some embodiments, information provided by the service provider 302 may be put by the resource provider 306 in an internal queue and all user data may be served up to an in-store customer service guide (i.e., an employee of the resource provider 306).

At step 7, the generated product recommendations may be provided to a user device. In some embodiments, the product recommendations may be provided to a user device operated by the user. In these embodiments, the user device may be caused to display the recommendations and note their availability in the physical store as well as various attributes of the products. In some embodiments, the generated product recommendations may be provided to a user device operated by the in-store customer service guide. The in-store customer service guide may access information about the user, which helps the customer service guide to make highly relevant recommendations to the user. For example, these outputs may include (in addition to the generated product recommendations) a name, a date the user last visited the store, the user's typical spend per visit over the past several periods, the user's preferred “Lifestyle” (physical and or mental effects desired by a user) and “Consumption Method,” the user's list of recent products purchased, the user's ratings of products purchased, or any other suitable information.

The user may then either self-shop by scanning products to research the product or adding them into to their cart (physical or electronic) for purchase. When added to an electronic cart, products may be fulfilled and made ready for pick up to expedite the purchasing process for the user. In some embodiments, payment processing may also be available via the application so the customer only needs to walk up to the counter to collect their purchase. Each purchase may be time-stamped, and recorded in a purchase database along with the list of exact products purchased (e.g., by Lot ID), employees whom assisted the user, and the employee whom checked the user out. This allows for internal management metrics to be gathered and displayed via a metric system (e.g., POTS “Point of Truth System”).

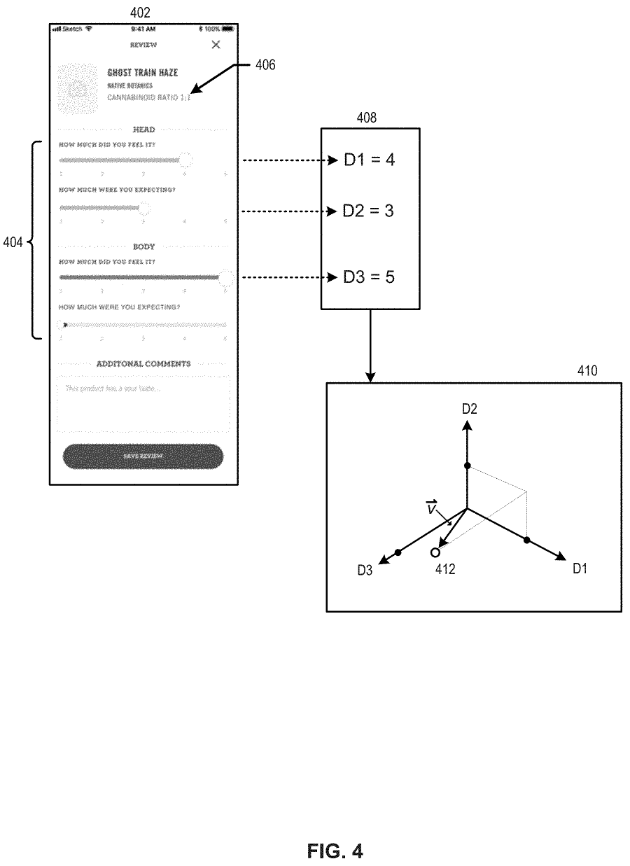

FIG. 4 depicts a technique for assigning a value to a user based on feedback received from that user in accordance with embodiments described herein. The value assigned to the user may be used in clustering to group the user with users which are similarly impacted by features of a product. As depicted in FIG. 4, a user may be enabled to provide feedback in relation to a particular product. For example, the user may be presented with feedback questionnaire via a graphical user interface (GUI) 402 in which the user is asked to provide numerical/quantitative feedback 404 related to the product. The product may be associated with particular features and/or attribute values 406.

In some embodiments, the feedback 404 is used to generate a data set 408 associated with the user from whom the feedback is received. In data set 408, each data value may be associated with a different dimension D, such that the data set 408 may be represented within a multi-dimensional space 410. For example, separate feedback values may be assigned to dimensions D1, D2, and D3, such that a point 412 within multidimensional space 410 is representative of the user with respect to particular features and/or attribute values 406. In some embodiments, the multidimensional space may also include data values for the user, such as a height, weight, or gender of the user. Note that the data set 408 may include data values particular to the user, such as height, weight, age, sex, etc. Additionally, data set 408 may include data values for a number of different products (or product attributes).

Once mapped to a multidimensional space 410, point 412, or a vector \vec{v} associated with point 412, can then be used to group the user with users who have been similarly affected by the product (or a product having similar attribute values 406). For example, a user associated with point 412 may be assigned to a cluster centroid which is the shortest distance away. In this way, the system is able to determine a group of users which have had a similar experience using a similar product. Note that one skilled in the art would be familiar with a number of clustering techniques which would be suitable for use here. A product capable of being used to achieve a particular lifestyle can then be ascertained by assessing feedback that others in the group of users to which the user has been assigned have provided. For example, the system may receive feedback that the user has provided in relation to a first product. The user may then be assigned to a particular cluster of users which have had a similar experience with the first product. The user may also provide an indication of a lifestyle that the user would like to achieve. Once the user has been assigned to a cluster, the system may assess feedback that others in the cluster have provided in order to determine a likely effect that various other products are likely to have on the user based on the effect that it has had on the other users of the cluster. The system then identifies a product or products most likely to achieve the desired lifestyle from that assessment. Note that because access to small-batch products, such as marijuana products, varies greatly based on location and availability, tying the clustering of a user to product features 406 as opposed to a product itself allows the system to adapt its recommendation to products available at a particular location.

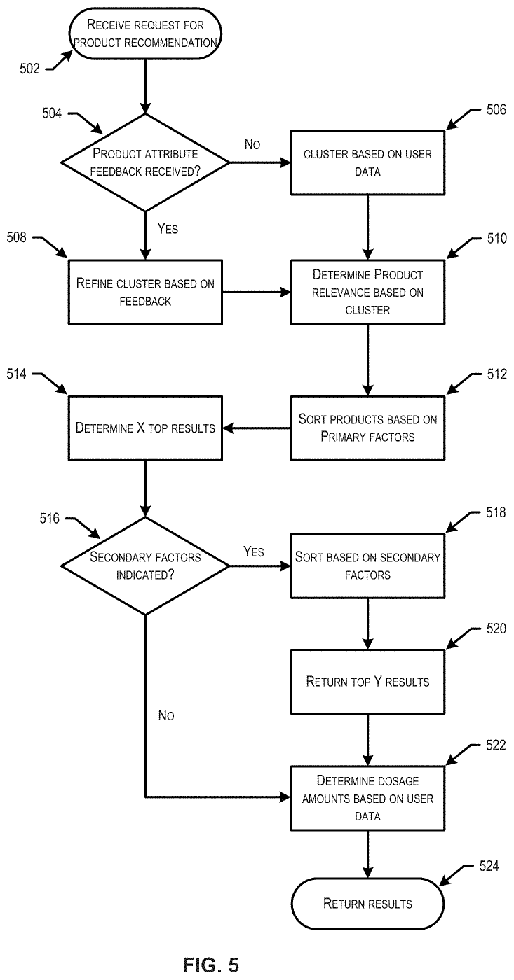

FIG. 5 depicts a process for generating personalized product recommendations for a user based on a selection of lifestyle and location in accordance with at least some embodiments. Some or all of the process 500 (or any other processes described herein, or variations and/or combinations thereof) may be performed under the control of one or more computer systems configured with executable instructions and may be implemented as code (e.g., executable instructions, one or more computer programs or one or more applications). In accordance with embodiments of the disclosure, the process 500 of FIG. 5 may be performed by at least the service provider server 200 and user device 228 shown in FIG. 2. The code may be stored on a computer-readable storage medium, for example, in the form of a computer program including a plurality of instructions executable by one or more processors. The computer-readable storage medium may be non-transitory.

Process 500 may begin at 502, when a request is received for a product recommendation in relation to a category of product having a high amount of brand variance and/or limited availability (e.g., geographic availability). In some embodiments, the request may be received automatically upon execution of a mobile software application on a user device. Upon receiving the request, a user associated with the request may be identified and details associated with that user (e.g., height, weight, etc.) may be retrieved from an account maintained for the user.

At 504, the process 500 involves determining whether the user identified in relation to the request has provided feedback regarding one or more products that they have consumed. Upon determining that the user has not previously provided feedback regarding one or more products, the user may be clustered with other users based on user data at 506. For example, the user may be clustered with others based on the user's height, weight, age, gender, body-mass index, or any other suitable factor. Upon determining that the user has previously provided feedback regarding one or more products, the feedback may be used to refine a cluster to which the user belongs at 508. An example of techniques for assigning a value to a user based on feedback received from that user which can be used to assign the user to a cluster is described in greater detail with respect to FIG. 4 above. Once a cluster has been identified, feedback regarding various products may be retrieved in relation to the members of the cluster.

At 510, the process 500 involves determining, for each of a number of products, a relevance of the product to the determined user. In some embodiments, a number of products may first be identified based on a location of the user. For example, the number of products may be determined by virtue of being located within some geographic distance of the user. Products may then be filtered based on an indicated consumption method. The likely effect that the product will have on the user is determined based on feedback received from the cluster of users in relation to a product having the same attributes (e.g., cannabinoid ratio, etc.) as the product. The relevance of the product may then be determined based upon a selected lifestyle of the user matching the likely effect that the product will have on the user. Each product may be assigned a value that represents a degree to which the likely effect on the user aligns with the selected lifestyle.

At 512, the process 500 involves sorting the products in the number of products based on primary factors. More particularly, products are sorted according to their relevance score and/or consumption method. One skilled in the art would recognize that a number of suitable sorting algorithms can be used to do this. Products may be sorted in ascending or descending order based on their relevance score.

At 514, the process 500 involves selecting some predetermined number of products from the sorted list of products. For example, the process may involve selecting the top X products based on relevance score, where X is some predetermined number. Note that this step may be optional, in that the entire sorted list of products may be returned, albeit in the sorted order.

At 516, the process 500 involves determining whether the products should be sorted based on secondary factors. This determination may be made based on preferences or settings stored in relation to a user's account. For example, if the user has indicated certain preferences, then those preferences may be treated as secondary factors that the products may be sorted on. However, if no such secondary factors exist, then the process may continue to 522.

At 518, the process 500 involves further sorting the predetermined number of products according to secondary factors upon determining that secondary factors exist. For example, a user may have stored, in relation to his or her account, flavor preferences that indicate a user's preference for certain flavor notes. In this example, a user's flavor preferences may be considered a secondary factor, such that the relevance score for each product in the predetermined number of products is adjusted based on the degree to which flavor notes in a flavor profile associated with the product match flavor preferences of the user. In some embodiments, the predetermined number of products may be further sorted based on secondary factors automatically (e.g., without user interaction).

At 520, the process 500 may involve selecting some second predetermined number of products from the sorted predetermined number of products. For example, the process may involve selecting the top Y products based on relevance score, where Y is some second predetermined number. Note that this step may be optional, in that the entire sorted list of products may be returned, albeit in the sorted order.

At 522, the process 500 may optionally involve determining an appropriate dose of the product. To do this, a potency of the products is assessed in relation to data known for the user (e.g., height, weight, etc.). In some cases, a potency value of the product may be determined based on specifications for the product which were received from the manufacturer. In some cases, the potency value of the product may be determined based on feedback received from consumers of the product. Dosage information may be generated by first calculating a quantity of the product appropriate to achieve a particular effect in an average person of the user's gender. The dosage may then be adjusted proportionally based on the user's relative size with respect to that of an average person of the user's gender. For example, if the user is male and is 0.89 times the size of an average male, then the dose may be calculated as 0.89 times the dosage for the average male.

At 524, the process 500 involves returning the results to the user. In some embodiments, the results may be returned in the form of a sorted list of products. In some embodiments, the top results or top few results may be returned to the user. In some embodiments, the results may be sorted by distance from the user and presented to the user in an order which reflects closest to furthest.

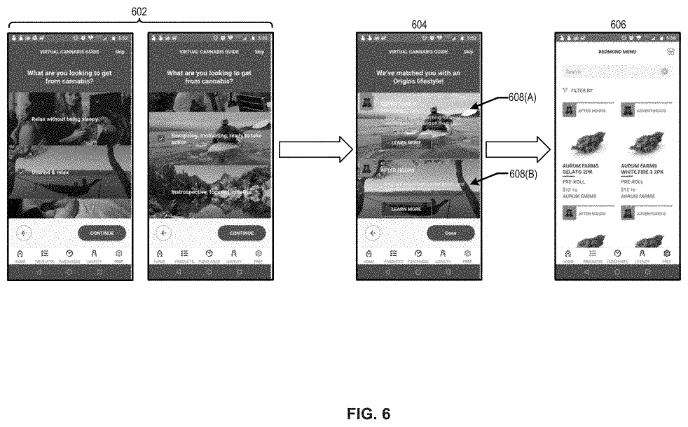

FIG. 6 depicts an illustrative example of various graphical user interfaces (GUIs) that may be implemented on a user device in accordance with at least some embodiments. In FIG. 6, a process for receiving input from a user and providing product recommendations is depicted as a series of GUIs 602, 604 and 606. Note that each of the GUIs 602, 604 and 606 may be implemented via a software application installed upon a user device operated by a user. In some embodiments, the software application may be a browser application used to access content maintained on a website. In some embodiments, the software application may be a special-purpose software application configured to perform the functionality described herein.

A user of the mobile application installed on a user device may submit a request for product recommendations. Note that in some cases, execution of the mobile application may constitute a request for a product recommendation. As depicted in GUIs 602, a user may be prompted to provide input regarding one or more effects that the user wishes to achieve by using a product (e.g., a cannabis product) for which recommendations have been requested. In some embodiments, the user may select one or more effects from a list of available effects via check boxes as illustrated. In some embodiments, the user may select effects from a drop-down menu or other selection means.

Once the mobile application has received input from the user regarding a selection of one or more desired effects, the mobile application may identify and present one or more lifestyles 608 that corresponds to the received selection as depicted at 604. In a scenario in which the user has indicated multiple desired effects, multiple lifestyles may be recommended which correspond to the multiple desired effects. For example, as depicted at 604, lifestyle 608(A) and 608(B) may be recommended to the user upon receiving the user's input via 602.

Once one or more lifestyles have been selected for the user, products determined to be likely to enable the user to achieve the one or more lifestyles may be presented to the user at 606. Note that an example process for generating a set of products to achieve the one or more lifestyles is described in greater detail with respect to FIG. 5 above. Once presented, a user may be provided with the ability to purchase or reserve one or more of the products. In some embodiments, the products may be sorted based on geographic availability. For example, the products may be sorted based on their location of availability, such that products which are available from a closer location are presented before products which are available from a further location.

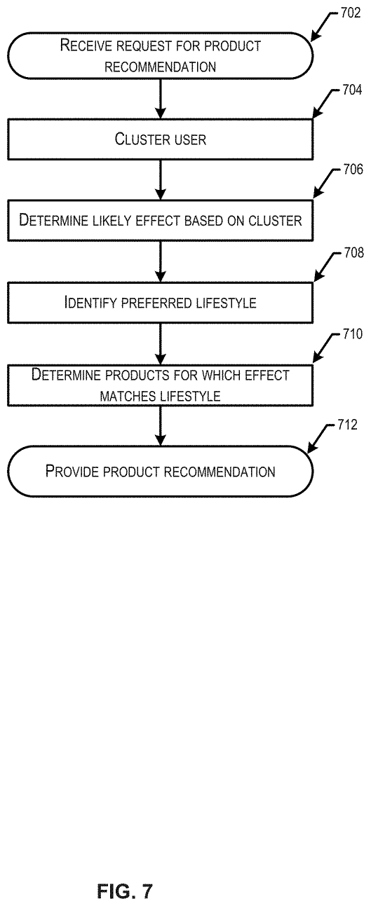

FIG. 7 depicts a flow diagram illustrating a process for providing a product recommendation in accordance with at least some embodiments. In accordance with at least one embodiment, the process 700 of FIG. 7 may be performed by at least the service provider server 200 described with respect to FIG. 2.

At 702, the process involves receiving a request for a product recommendation in relation to a user. In some embodiments, the request is received in relation to a user from a user device associated with that user. In some embodiments, an agent or employee of a retail location may request a list of products recommended for a user visiting the retail location. The request may include an indication of a preferred lifestyle, a consumption method, a set of desired effects, a location associated with the user device, user details, or any other suitable data. The set of products for which a recommendation is requested may be a set of cannabis products.

At 704, the process involves determining a cluster for the user based on attributes associated with the user. In some embodiments, the cluster for the user is determined based at least in part on a height, weight, or gender of the user. In some embodiments, the cluster for the user is determined based at least in part on feedback provided by a user in relation to at least one product.

At 706, the process involves determining a likely effect for each of a set of products on the user based on the determined cluster. In embodiments in which the products for which a recommendation is requested are cannabis products, the likely effect for each of a set of products determined based on a cannabinoid ratio for each of the cannabis products. In at least some of these embodiments, the likely effect may be determined based on amounts or ratios for particular cannabinoids. For example, CBN and CBG are often preferred for sleep, so products with higher levels of these cannabinoids would be used as preferred products if customers are looking for sleep aid (e.g., a relaxing lifestyle). In some embodiments, the likely effect for each of the set of products is determined based at least in part on feedback provided by at least one second user of the cluster in relation to the set of products.

At 708, the process involves identifying a preferred lifestyle for the user. In some embodiments, an indication of the preferred lifestyle may be included within the request for product recommendations. In some embodiments, the preferred lifestyle may be determined based on data stored in relation to the user. For example, preferences or user settings stored in relation to an account maintained for the user may be used to determine a preferred lifestyle for that user. In some embodiments, the preferred lifestyle may be determined from a set of desired effects provided in the request for product recommendations.

At 710, the process involves identifying a subset of the set of products for which the determined likely effect matches the preferred lifestyle. To do this, the process may first involve determining a set of products available to the user. In some embodiments, the set of products may include all products within a product catalog. In some embodiments, the set of products may include products available within a geographic radius of the originator of the request. In some embodiments, the process also involves determining a dosage associated with one or more products of the subset of the set of products. To do this, the dosage is determined based at least in part on a potency associated with the one or more products and data associated with the user (i.e., height, weight, or gender).

At 712, the process involves providing an indication of the subset of the set of products in response to the request. In some embodiments, the subset of the set of products is provided to a user device associated with the user from which the request originated. For example, a user may request a recommendation via his or her user device and be provided a list of products on that user device. In some embodiments, the indication of the subset of the set of products is provided to an agent employed by a resource provider. For example, an agent or employee of a retail location may request a list of products recommended for a user visiting the retail location and may be provided with a list of products located at that retail location which suit the user. Note that the subset of the set of products may be filtered based on a preferred consumption method. In some embodiments, the subset of the set of products is sorted based on a geographic distance of each product to the user device.

The process 700 may further involve a step for enabling acquisition of one or more products. For example, the process may involve receiving a selection of a product from the subset of the set of products, identifying a resource provider for the selected product of the subset of the set of products, and providing notification to the resource provider. In some embodiments, providing such notification may include enabling the user to purchase the product and either shipping the product to the user or having the resource provider make the product available for pickup. In some embodiments, providing such notification may include generating a message to the resource provider requesting a reservation of the product for the user.

Embodiments of the disclosure provide for a number of advantages over conventional systems. For example, the system enables highly personalized recommendations for products that vary greatly in performance. It should be noted that while a number of recommendation engines exist, cannabis products often vary greatly in both performance and effect and often on a person-by-person basis. Additionally, cannabis products may only be available to a limited number of cannabis retailers, and products offered for sale may also vary greatly between retail stores. It is often difficult to ascertain which products from one retailer are equivalent to a product that the user prefers which is offered by a different retailer. Hence, conventional recommendation engines, while sufficient at providing recommendations for uniform products, are often unable to provide realistic recommendations to a user for varied or small-batch products. Additionally, conventional product recommendation systems often make recommendations based on items having been previously purchased. For example, an item-to-item recommendation system may recommend products that have previously purchased by users who have purchased other products that a user has purchased. In another example, person-to-person recommendation systems may recommend products that have been purchased by users similar to the user. The present disclosure addresses these issues by identifying attributes of each product (e.g., cannabinoid ratio). The attributes can then be used, along with attributes of a user (e.g., height, weight, gender, etc.) as well as received feedback to determine an effect that the product is likely to have on the user. That effect can then be compared to a lifestyle and consumption mode that the user is seeking. In this way, the recommendation engine can provide recommendations across products and retailers even where previous purchases of the product have not been made.

It should be understood that any of the embodiments of the present disclosure can be implemented in the form of control logic using hardware (e.g. an application specific integrated circuit or field programmable gate array) and/or using computer software with a generally programmable processor in a modular or integrated manner. As used herein, a processor includes a single-core processor, multi-core processor on a same integrated chip, or multiple processing units on a single circuit board or networked. Based on the disclosure and teachings provided herein, a person of ordinary skill in the art will know and appreciate other ways and/or methods to implement embodiments of the present disclosure using hardware and a combination of hardware and software.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present disclosure may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of the disclosure will become apparent to those skilled in the art upon review of the disclosure. The scope of the disclosure should, therefore, be determined not with reference to the above description, but instead should be determined with reference to the pending claims along with their full scope or equivalents.

One or more features from any embodiment may be combined with one or more features of any other embodiment without departing from the scope of the disclosure.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A computer-implemented method comprising:
receiving, at a service provider computer, a request to provide a personalized product recommendation to a user;
determining, by the service provider computer based on attributes associated with the user, a cluster to which the user belongs;
determining, by the service provider computer based on information stored in association with the cluster, a likely effect for each of a set of products;
identifying, by the service provider computer, a preferred lifestyle for the user;
identifying, by the service provider computer, a subset of the set of products for which the determined likely effect matches the preferred lifestyle; and
providing, by the service provider computer, an indication of the subset of the set of products in response to the request.

2. The method of claim 1, wherein the set of products comprises a set of cannabis products.

3. The method of claim 2, wherein the likely effect for each of a set of products is also determined based on a cannabinoid ratio for each of the cannabis products.

4. The method of claim 1, wherein the indication of the subset of the set of products is provided to a user device associated with the user.

5. The method of claim 1, wherein the indication of the subset of the set of products is provided to an agent employed by a resource provider.

6. The method of claim 1, wherein the subset of the set of products are filtered based on a preferred consumption method.

7. The method of claim 1, wherein the preferred lifestyle is indicated in the request to provide the personalized product recommendation.

8. The method of claim 1, wherein the preferred lifestyle is determined based on data stored in relation to the user.

9. The method of claim 1, wherein the cluster to which the user belongs is determined at least in part on a height, weight, or gender of the user.

10. The method of claim 1, wherein the cluster to which the user belongs is determined at least in part on feedback provided by a user in relation to at least one product.

11. The method of claim 10, wherein the likely effect for each of the set of products is determined at least in part on feedback provided by at least one second user of the cluster in relation to the set of products.

12. A service provider computer comprising:
a processor; and
a memory including instructions that, when executed with the processor, cause the service provider computer to, at least:
receive a request to provide a personalized product recommendation to a user device of a user;
determine, based on attributes associated with the user, a cluster to which the user belongs;
determine, based on information stored in association with the cluster, a likely effect for each of a set of products;
identify a preferred lifestyle for the user;
identify a subset of the set of products for which the determined likely effect matches the preferred lifestyle; and
provide an indication of the subset of the set of products in response to the request.

13. The service provider computer of claim 12, wherein the instructions further cause the service provider computer to receive a set of desired effects from the user device of the user, and wherein the preferred lifestyle for the user is identified from the set of desired effects.

14. The service provider computer of claim 12, wherein the instructions further cause the service provider computer to receive an indication of a location associated with the user device of the user, and wherein the set of products is generated to include products available within a geographic radius of the user device.

15. The service provider computer of claim 12, wherein the instructions further cause the service provider computer to receive an indication of a location associated with the user device of the user, and wherein the subset of the set of products is sorted based on a geographic distance of each product to the user device.

16. The service provider computer of claim 12, wherein the instructions further cause the service provider computer to:
receive a selection of a product from the subset of the set of products;
identify a resource provider for the selected product of the subset of the set of products; and
generate a message to the resource provider requesting a reservation of the product for the user.

17. The service provider computer of claim 12, wherein the instructions further cause the service provider computer to determine a dosage associated with one or more products of the subset of the set of products.

18. The service provider computer of claim 17, wherein the dosage is determined based at least in part on a potency associated with the one or more products and data associated with the user.

19. The service provider computer of claim 18, wherein the data associated with the user comprises at least one of a height, weight, or gender.

20. The service provider computer of claim 12, wherein the subset of the set of products is sorted based on a flavor preference stored in relation to the user and a flavor profile associated with the product.
